(19) United States
(12) Patent Application Publication
(10) Pub. No.: US 2019/0164106 A1
(43) Pub. Date: May 30, 2019

(54) ABILITY EVALUATION SYSTEM

(71) Applicant: JTEKT CORPORATION, Osaka-shi (JP)

(72) Inventors: Kazuma SUZUKI, Kariya-shi (JP); Guangyu ZHU, Kariya-shi (JP); Masahiro HAYASHI, Kariya-shi (JP); Yasuhiro KONDOU, Kiyosu-shi (JP)

(73) Assignee: JTEKT CORPORATION, Osaka-shi (JP)

(21) Appl. No.: 16/195,035

(22) Filed: Nov. 19, 2018

(30) Foreign Application Priority Data
Nov. 24, 2017 (JP) 2017-225362

(51) Int. Cl. G06Q 10/06; G06Q 50/04

(52) U.S. Cl. CPC G06Q 10/06398; G06Q 50/04

(57) ABSTRACT

An ability evaluation system includes an operation time acquisition device configured to acquire operation times of operators, a reference time storage device configured to store reference times of operations, and a production-related ability calculation device configured to calculate, for each of the operators, a production-related ability of each of the operators based on the acquired operation times and the reference time of a corresponding operation by causing a computer to execute first arithmetic processing set in advance. The production-related ability calculation device is configured to calculate the production-related ability based on an achievement value that is a ratio at which the acquired operation times of a plurality of operations achieve the reference time, and based on a stability value of the acquired operation times of the plurality of operations.

### INCORPORATION BY REFERENCE

The disclosure of Japanese Patent Application No. 2017-225362 filed on Nov. 24, 2017 including the specification, drawings and abstract, is incorporated herein by reference in its entirety.

### BACKGROUND OF THE INVENTION

### 1. Field of the Invention

The present invention relates to an ability evaluation system.

### 2. Description of the Related Art

Japanese Patent Application Publication No. 2001-166681 (JP 2001-166681 A) states that operation results are evaluated based on operation time data and operation quality data and an operator's learning level is evaluated based on the operation results.

Japanese Patent No. 4176416 (JP 4176416 B) describes determination on an operation learning level of an operator. The determination on the operation learning level is made based on one or more items out of an operation time learning level for determination on the operator's learning level based on an actual operation time, a quality learning level for determination on the operator's learning level based on the number of failures, and a general operation learning level for determination based on the total of the operation time learning level and the quality learning level.

The determination on the operation time learning level is made by comparing an actual operation time and a standard operation time. The actual operation time is obtained by removing an ineffective operation that is not ascribed to the operator from data obtained by analyzing and measuring an operation image. The standard operation time is stored in advance. The determination on the quality learning level is made based on the number of quality deficiencies caused by the operator and found in assembling and inspection steps during manufacturing, excluding non-operator's factors including problems with the quality of parts, and based on the number of quality deficiencies caused by the operator and found in a final inspection step, excluding non-operator's factors including problems with the quality of parts.

The determination on the operator's learning level can be made based on both the operation speed and the operation quality by checking “failed” items in the inspection step in addition to the operation time of the operator and comprehensively extracting failures caused by the operator.

When the operator's learning level (ability) is evaluated based on the operation time, it is not sufficient to evaluate only the speed of the operation. When the operator's quality is evaluated, it is not sufficient to evaluate only the number of quality deficiencies.

### SUMMARY OF THE INVENTION

It is one object of the present invention to provide an ability evaluation system capable of evaluating an operator's ability more appropriately.

An ability evaluation system according to one aspect of the present invention includes:

an operation time acquisition device configured to acquire operation times of operators;

a reference time storage device configured to store reference times of operations; and

a production-related ability calculation device configured to calculate, for each of the operators, a production-related ability of each of the operators based on the acquired operation times and the reference time of a corresponding operation by causing a computer to execute first arithmetic processing set in advance.

The production-related ability calculation device is configured to calculate the production-related ability based on an achievement value that is a ratio at which the acquired operation times of a plurality of operations achieve the reference time, and based on a stability value of the acquired operation times of the plurality of operations.

As described above, the operator's production-related ability is calculated based on the achievement value and the stability value. The achievement value is rated higher as the operation time is shorter. The stability value is rated higher as variation of the operation times of the plurality of operations is smaller. That is, an operator whose operation time constantly achieves the reference time is high in terms of the achievement value and also high in terms of the stability value. Thus, the operator's ability is rated high. For example, in a case of a plurality of operators whose achievement values are approximately equal to each other, the operator who has a significant delay in a case where the operation time does not achieve the reference time is low in terms of the stability value, whereas the operator who has a slight delay in the case where the operation time does not achieve the reference time is high in terms of the stability value. That is, when the achievement values are approximately equal to each other, the operator's ability is rated higher as the stability value is higher. Thus, the operator's ability can be evaluated more appropriately in consideration of the stability value in addition to the achievement value for the reference time.

An ability evaluation system according to another aspect of the present invention includes:

an inspection result information acquisition device configured to acquire inspection result information obtained in quality inspection conducted as a step subsequent to operations performed by operators; and

a quality-related ability calculation device configured to calculate, for each of the operators, a quality-related ability for the operations performed by each of the operators based on the inspection result information by causing a computer to execute arithmetic processing set in advance.

The quality-related ability calculation device is configured to calculate the quality-related ability based on a short-term quality satisfaction value obtained as one element of the quality-related ability based on pieces of the inspection result information on the operations performed in a predetermined short term, and based on a long-term quality satisfaction value obtained as another element of the quality-related ability based on pieces of the inspection result information on the operations performed in a predetermined long term.

For example, an operator may have an ability to produce products with satisfactory qualities in the long term, but the ability to produce products with satisfactory qualities may decrease in the short term due to a poor physical condition or the like. Alternatively, an operator has not yet had an ability to stably produce products with satisfactory qualities in the long term, but may have an ability to produce products with satisfactory qualities in the short term when the operator exhibits remarkable growth. By calculating the operator's quality-related ability based on the long-term quality satisfaction value and the short-term quality satisfaction value, the operator's quality-related ability can be evaluated appropriately even in the cases described above.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram of a production facility structured by a plurality of cells;

FIG. 2 is a functional block diagram of an ability evaluation system;

FIG. 3 is an illustration of operation times of five operations in each of cells A1, A2, and A3 in a first assembling step;

FIG. 4 is an illustration of times, total times, and average times in the cells A1, A2, and A3, which are used by a production-related ability calculation device for achievement value calculation;

FIG. 5 is an illustration of times and standard deviations in the cells A1, A2, and A3, which are used by the production-related ability calculation device for stability value calculation;

FIG. 6 is a diagram illustrating a relationship among an achievement value, a stability value, and a production-related ability, which is used by the production-related ability calculation device for production-related ability calculation;

FIG. 7 is a diagram illustrating inspection items and results in an inspection step;

FIG. 8 is a diagram illustrating a relationship between the inspection items and corresponding steps in the inspection step;

FIG. 9 is a graph of product dimensions and the number of distributed items, illustrating a design reference value, a permissible-quality range, and a high-precision range;

FIG. 10 is an illustration of the number of operations, a “failed” inspection item, a long-term evaluation point, and a short-term evaluation point regarding operations performed in the cell A1 up to a current time point;

FIG. 11 is an illustration of a relationship among a long-term quality level, a short-term quality level, and a quality satisfaction value;

FIG. 12 is a diagram illustrating a relationship among the quality satisfaction value, a range fitness value, and a quality-related ability, which is used by a quality-related ability calculation device for quality-related ability calculation;

FIG. 13 is a diagram illustrating a relationship among the production-related ability, the quality-related ability, and a general ability, which is used by a general ability calculation device for general ability calculation;

FIG. 14 is a diagram illustrating an example of contents presented by a presentation device;

FIG. 15 is a diagram illustrating another example of the contents presented by the presentation device; and

FIG. 16 is a diagram illustrating still another example of the contents presented by the presentation device.

### DETAILED DESCRIPTION OF EMBODIMENTS

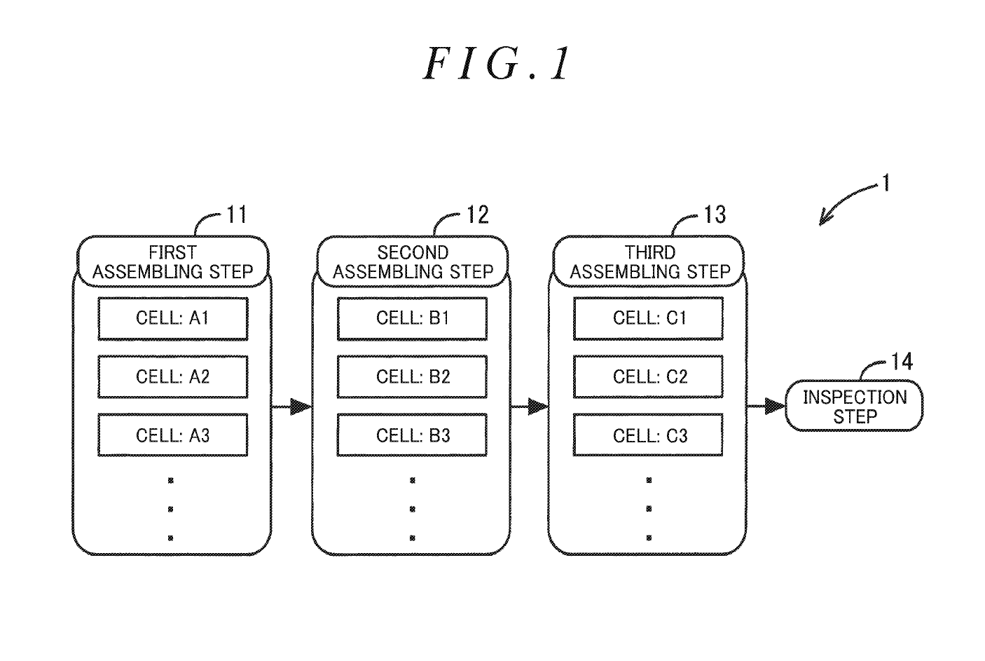

A production facility 1 applied to an ability evaluation system is described with reference to FIG. 1. The production facility 1 is a facility for producing various products. For example, the production facility 1 is used for producing automobiles, automotive parts, or industrial equipment.

As illustrated in FIG. 1, a case of applying cell production to the production facility 1 is taken as an example. The production facility 1 organizes a first assembling step 11, a second assembling step 12, a third assembling step 13, and an inspection step 14. In the first assembling step 11, production is performed by a plurality of cells A1, A2, and A3. In the second assembling step 12, production is performed by a plurality of cells B1, B2, and B3 by using intermediate products produced in the first assembling step 11. In the third assembling step 13, production is performed by a plurality of cells C1, C2, and C3 by using intermediate products produced in the second assembling step 12. In the inspection step 14, products completed in the third assembling step 13 are inspected.

The number of assembling steps may be set arbitrarily. The inspection step 14 may be provided between assembling steps instead of being provided as a final step. Although description is given of the cell production, line production is also applicable. The assembling step may be replaced with a machining step.

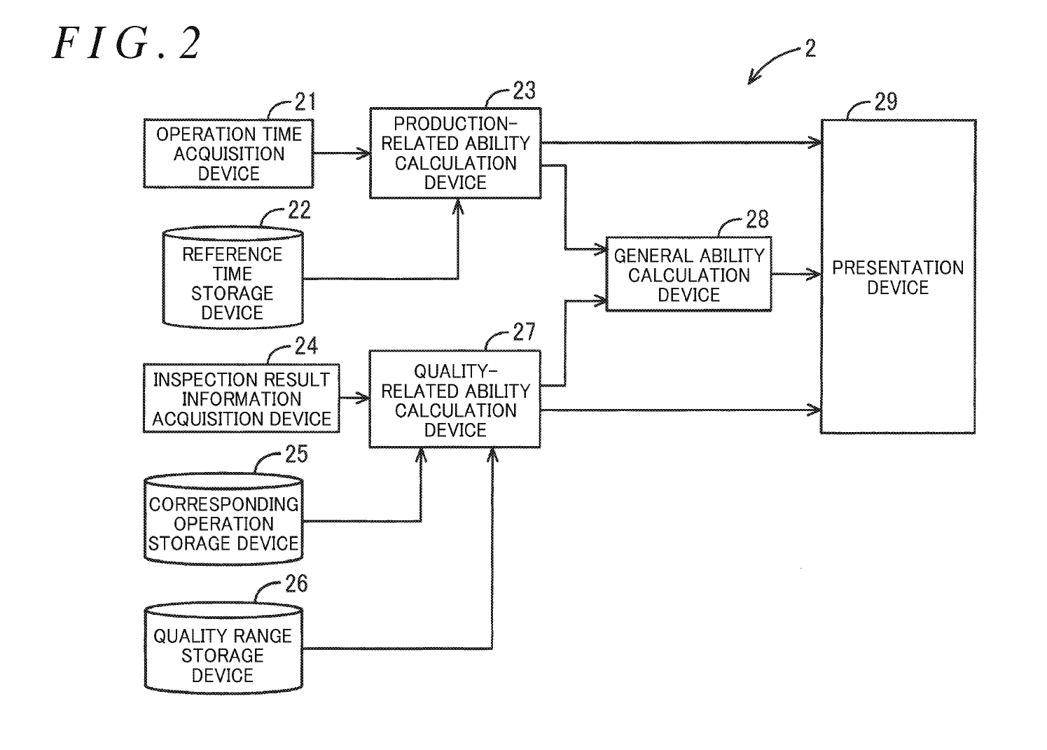

An ability evaluation system 2 (illustrated in FIG. 2) evaluates abilities of operators in charge of the cell A1 and the like in the first assembling step 11 of the production facility 1, operators in charge of the cell B1 and the like in the second assembling step 12, and operators in charge of the cell C1 and the like in the third assembling step 13. The ability evaluation system 2 calculates an operator's production-related ability based on an operation time of each operator, calculates an operator's quality-related ability based on inspection result information obtained in the inspection step 14, and calculates a general ability based on the production-related ability and the quality-related ability. For example, each of the production-related ability, the quality-related ability, and the general ability is represented by a plurality of (for example, five) levels. A higher level represents a higher ability.

The ability evaluation system 2 is described in detail with reference to FIG. 2 to FIG. 14. The ability evaluation system 2 includes an operation time acquisition device 21, a reference time storage device 22, a production-related ability calculation device 23, an inspection result information acquisition device 24, a corresponding operation storage device 25, a quality range storage device 26, a quality-related ability calculation device 27, a general ability calculation device 28, and a presentation device 29.

The operation time acquisition device 21 acquires an operation time of each operation performed by each operator (time required for a series of operations). For example, a start button for indicating the start of an operation and a finish button for indicating the finish of the operation are installed in an operation area of each operator. The operator operates the start button and the finish button. In this case, the operation time acquisition device 21 acquires, as the operation time of each operation, a period of time from a time point at which each operator operates the start button when one operation (corresponding to a series of operations) is started to a time point at which the operator operates the finish button when the operation is finished. For example, in a case of an operator of the cell A1 in the first assembling step 11, a period of time from a time point at which the operator operates the start button when one operation is started in the cell A1 to a time point at which the operator operates the finish button when the one operation is finished in the cell A1 is acquired as an operation time of each operation performed by the operator in the cell A1. In place of the system using the start button and the finish button, a system capable of automatically detecting the start and finish of an operation may be employed. This system can automatically acquire the operation time by automatically acquiring a start time point and a finish time point.

The reference time storage device 22 stores a reference time of each operation. For example, the reference time storage device 22 stores a reference time of an operation in the first assembling step 11, a reference time of an operation in the second assembling step 12, and a reference time of an operation in the third assembling step 13. For example, the reference time is a period of time set in advance when production planning is determined. In this embodiment, the following description is given under the assumption that the reference time of the operation in the first assembling step 11 is 60 minutes.

The production-related ability calculation device 23 calculates an operator's production-related ability for each operator based on the acquired operation time and the reference time of the corresponding operation by causing a computer to execute first arithmetic processing set in advance. That is, the production-related ability calculation device 23 calculates, as the production-related ability, the degree of closeness of the acquired actual operation time to the reference time of the corresponding operation.

Specifically, the production-related ability calculation device 23 calculates the production-related ability by using two indices that are an achievement value and a stability value. That is, the production-related ability calculation device 23 calculates the production-related ability based on an achievement value that is a ratio at which acquired operation times of a plurality of operations achieve the reference time, and based on a stability value of the acquired operation times of the plurality of operations.

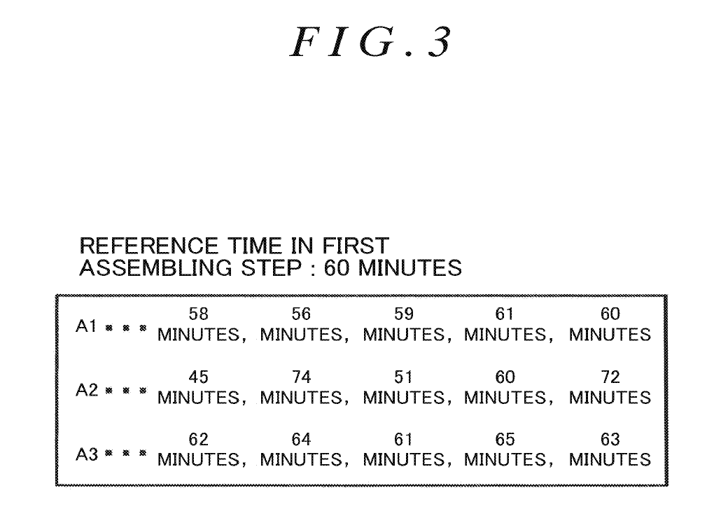

For example, FIG. 3 illustrates operation times of five operations in each of the cells A1, A2, and A3. The operation time acquisition device 21 acquires the operation times in each of the cells A1, A2, and A3. The reference time in the first assembling step 11 is 60 minutes.

The production-related ability calculation device 23 calculates the achievement value by using the acquired operation times. When the acquired operation time achieves the reference time, the production-related ability calculation device 23 substitutes the reference time for the acquired operation time. When the acquired operation time does not achieve the reference time, the production-related ability calculation device 23 directly uses the acquired operation time. The production-related ability calculation device 23 calculates an achievement value of the operation times of the plurality of operations for achievement time calculation.

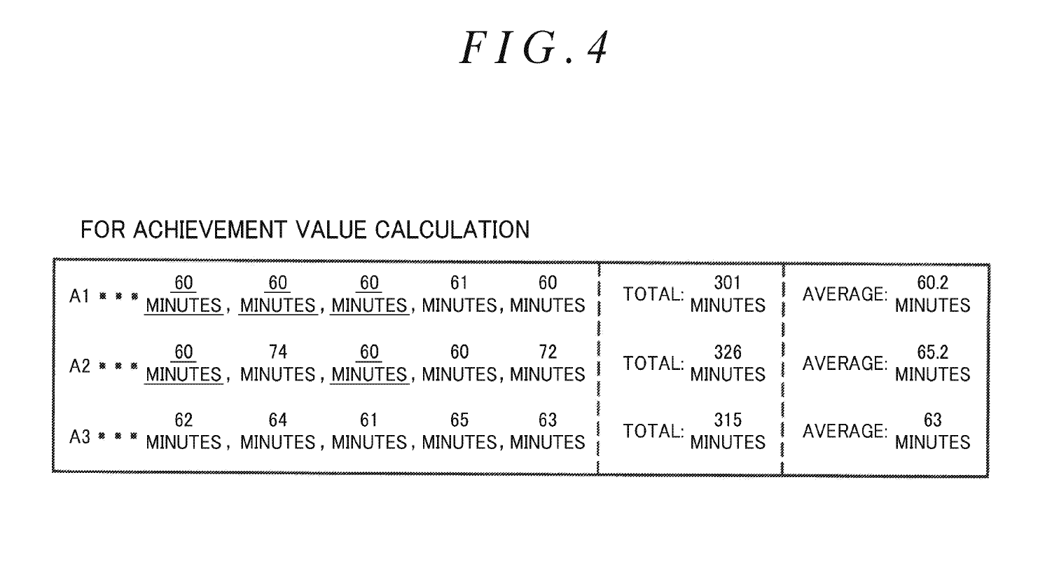

For example, when the actual operation times of five operations in the cell A1 are 58 minutes, 56 minutes, 59 minutes, 61 minutes, and 60 minutes, the operation times for achievement value calculation are converted to 60 minutes, 60 minutes, 60 minutes, 61 minutes, and 60 minutes as illustrated in FIG. 4. The reason is that evaluation is made as to whether the operation time achieves the reference time and, when the operation time does not achieve the reference time, evaluation is made as to how much the operation time does not achieve the reference time.

Then, the production-related ability calculation device 23 calculates, as one index to the achievement value, an average of the operation times of the plurality of operations that are obtained through the conversion for achievement value calculation. For example, the averages serving as the achievement values in the cells A1, A2, and A3 are 60.2 minutes, 65.2 minutes, and 63 minutes, respectively. When the average serving as the achievement value is 60 minutes, all the operation times achieve the reference time. When the average is larger than 60 minutes, the excess of time means how much the operation times do not achieve the reference time.

Then, the production-related ability calculation device 23 determines a level of the achievement value (hereinafter referred to as “achievement value level”) by using the average serving as the achievement value. The achievement value level is determined from among a plurality of (for example, five) levels. For example, when the average serving as the achievement value is small, the operator's achievement value level is high (for example, level 5). When the average serving as the achievement value is large, the operator's achievement value level is low (for example, level 1).

That is, among the three operators, the achievement value level of the operator in charge of the cell A1 is highest, and the achievement value level of the operator in charge of the cell A2 is lowest. Although the average is used as one index to the achievement value, the index is not limited to the average, but a different statistic may be used. For example, a statistic that can only demonstrate whether the operation time achieves the reference time may be used as the achievement value.

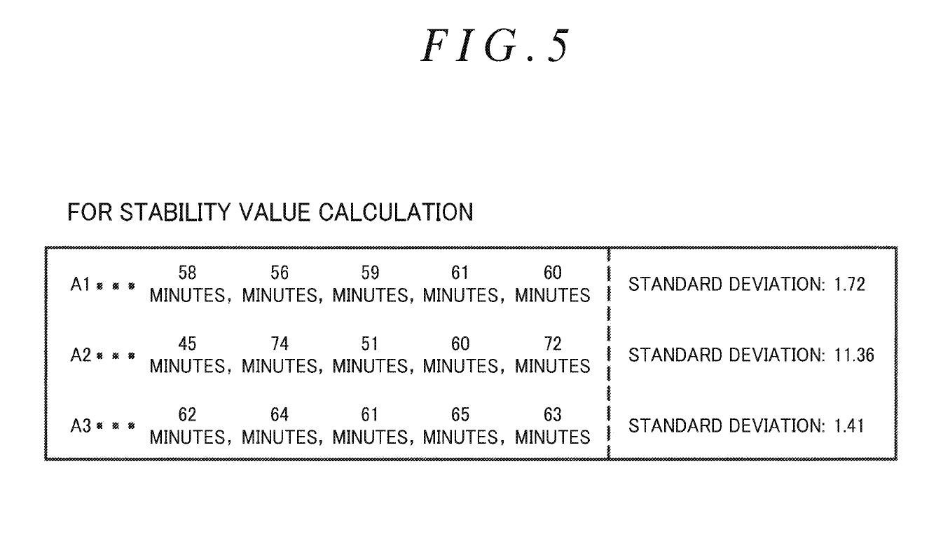

The production-related ability calculation device 23 calculates the stability value by using the acquired operation times. Unlike the case of achievement value calculation, the production-related ability calculation device 23 calculates the stability value of the operation times of the plurality of operations by directly using the acquired operation times. For example, when the actual operation times of five operations in the cell A1 are 58 minutes, 56 minutes, 59 minutes, 61 minutes, and 60 minutes, the operation times for stability value calculation are 58 minutes, 56 minutes, 59 minutes, 61 minutes, and 60 minutes as illustrated in FIG. 5.

Then, the production-related ability calculation device 23 calculates, as one index to the stability value, a standard deviation of the operation times of the plurality of operations for stability value calculation. For example, the standard deviations serving as the stability values in the cells A1, A2, and A3 are 1.72, 11.36, and 1.41, respectively. As the standard deviation is closer to 0, variation of the operation times is smaller.

Then, the production-related ability calculation device 23 determines a level of the stability value (hereinafter referred to as “stability value level”) by using the standard deviation serving as the stability value. The stability value level is determined from among a plurality of (for example, five) levels. For example, when the standard deviation serving as the stability value is small, the operator's stability value level is high (for example, level 5). When the standard deviation serving as the stability value is large, the operator's stability value level is low (for example, level 1).

That is, among the three operators, the stability value level of the operator in charge of the cell A3 is highest, and the stability value level of the operator in charge of the cell A2 is lowest. Although the standard deviation is used as one index to the stability value, the index is not limited to the standard deviation, but a different statistic may be used.

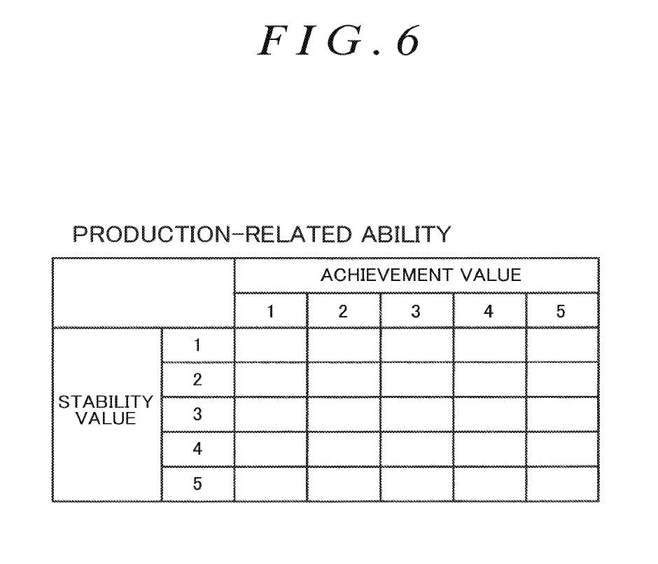

Then, the production-related ability calculation device 23 determines a level of the production-related ability as illustrated in FIG. 6 by using the achievement value level and the stability value level. For example, as illustrated in FIG. 6, the level of the production-related ability is determined from among five levels based on a matrix obtained by using five achievement value levels and five stability value levels. Although the achievement value level and the stability value level are used for determining the level of the production-related ability, the average of the operation times serving as one index to the achievement value and the standard deviation serving as one index to the stability value may be used. Instead of determining the level of the production-related ability based on the matrix, an average of the achievement value level and the stability value level may be used. At this time, weights may be assigned to the achievement value level and the stability value level.

The inspection result information acquisition device 24 acquires inspection result information obtained in quality inspection conducted as a step subsequent to each operation. In this embodiment, the inspection result information acquisition device 24 acquires inspection result information obtained in the inspection step 14. For example, the inspection result information acquisition device 24 acquires the inspection result information such that an operator in charge of the inspection step 14 inputs the inspection result information.

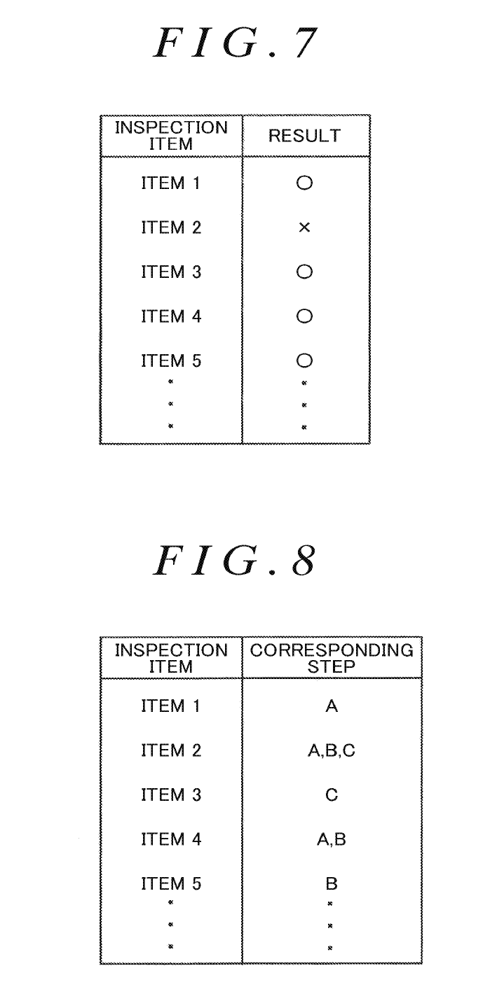

For example, as illustrated in FIG. 7, a plurality of inspection items are present in the inspection step 14, and an inspection result of each item indicates “good” or “failed”. For example, the case of “good” is represented by “O”, and the case of “failed” is represented by “X”. FIG. 7 illustrates a case where an inspection item 2 is “failed” and the other items are “good”. In this manner, the inspection result information acquisition device 24 acquires the result of the inspection item for each target product. Information on the target product includes information on a cell that handles the target product in each step (for example, information of A1, B1, or C1). That is, the inspection result information acquisition device 24 acquires information on the target product, the inspection item, the result of the inspection item, and the cell that handles the target product in each step.

The corresponding operation storage device 25 stores operations corresponding to respective pieces of inspection result information. For example, as illustrated in FIG. 8, operations corresponding to the respective items in the inspection step 14 are set in the corresponding operation storage device 25. The corresponding operation is an operation step on which the responsibility for the item lies. For example, operations corresponding to items 1 to 5 are “A”, “A, B, C”, “C”, “A, B”, and “B” as illustrated in FIG. 8, respectively. The operation step A is the first assembling step 11. The operation step B is the second assembling step 12. The operation step C is the third assembling step 13. That is, when the inspection result of the item 1 is “failed”, an operator in the operation step A (first assembling step 11) has responsibility for the item 1. When the inspection result of the item 2 is “failed”, operators in the operation steps A, B, and C (first, second, and third assembling steps 11, 12, and 13) have responsibility for the item 2.

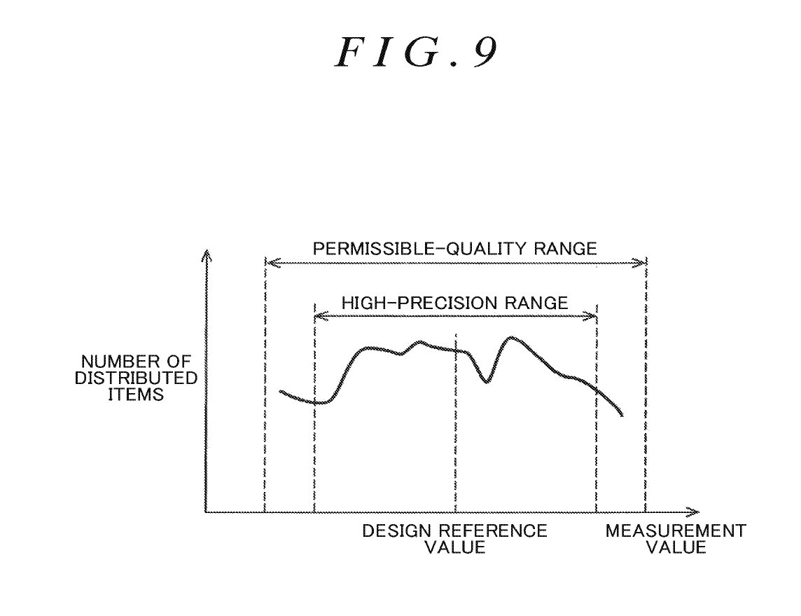

The quality range storage device 26 stores a permissible-quality range and a high-precision range narrower than the permissible-quality range. As illustrated in FIG. 9, the permissible-quality range is a range in which the quality is satisfactory with respect to a design reference value regarding a measurement value obtained through measurement on a product in the inspection step 14. For example, the permissible-quality range corresponds to a tolerance range of the design reference value. The high-precision range is narrower than the permissible-quality range, and is a range in which the quality is obtained with high precision with respect to the design reference value. The permissible-quality range is used for determining whether the quality of the product is satisfactory or unsatisfactory. When the measurement value falls within the permissible-quality range and also within the high-precision range, it is determined that the operator's quality-related ability is high. When the measurement value falls within the permissible-quality range but out of the high-precision range, it is determined that the operator's quality-related ability is low.

The quality-related ability calculation device 27 calculates, for each operator, the quality-related ability for the operations performed by the operator based on the inspection result information by causing the computer to execute second arithmetic processing set in advance. The inspection result information includes a quality satisfaction value and a range fitness value for the high-precision range (illustrated in FIG. 9). The quality satisfaction value is derived from the item inspection conducted in the inspection step 14. The range fitness value for the high-precision range is derived from a measurement result obtained in the inspection step 14. That is, the quality-related ability calculation device 27 calculates the quality-related ability by using two indices that are the quality satisfaction value and the range fitness value for the high-precision range.

The quality satisfaction value is calculated by using two indices that are a long-term quality satisfaction value (long-term quality level) and a short-term quality satisfaction value (short-term quality level). The long-term quality satisfaction value is an index to whether the quality falls within the permissible-quality range illustrated in FIG. 9 over a predetermined long term. That is, the long-term quality satisfaction value indicates how much a failure does not occur over the predetermined long term. For example, the predetermined long term is six months, one year, or a term ranging from an initial stage at which an operator starts to perform operations to a current time point. The short-term quality satisfaction value is an index to whether the quality falls within the permissible-quality range illustrated in FIG. 9 over a predetermined short term. That is, the short-term quality satisfaction value indicates how much a failure does not occur over the predetermined short term. For example, the predetermined short term may correspond to a predetermined number of operations counted from a recent time point when a failure occurs. Alternatively, the predetermined short term may be a specific term such as two weeks or one month. Still alternatively, the predetermined short term may correspond to a predetermined number of operations counted from the current time point.

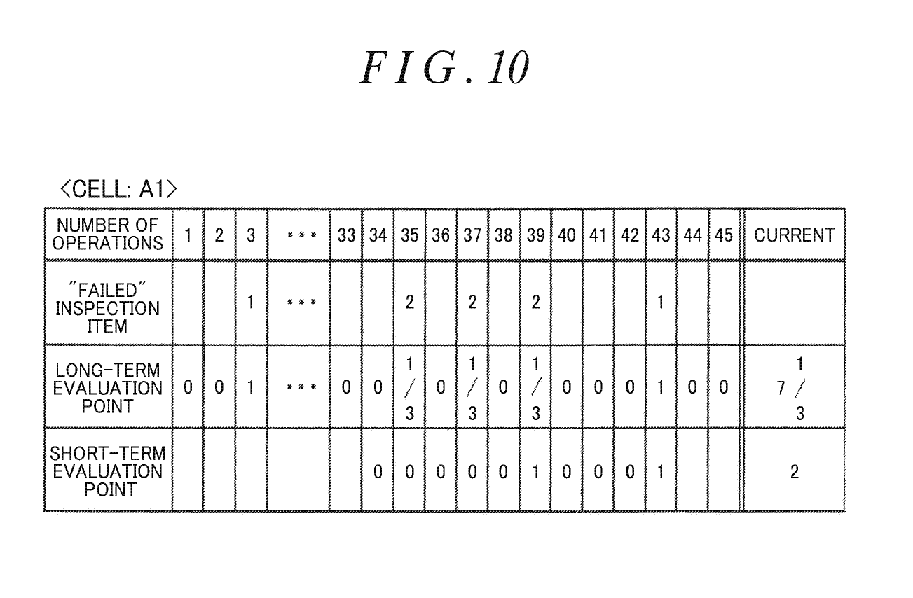

Examples of methods for calculating the long-term quality satisfaction value and the short-term quality satisfaction value are described with reference to FIG. 10. As illustrated in FIG. 10, the number of finished operations in the cell A1 is 45 at the current time point. An operation with an entry in a “failed” inspection item indicates determination that a corresponding inspection item (illustrated in FIG. 7) is “failed”. An operation with no entry in the “failed” inspection item indicates determination that all the items are “good”. For example, in the third operation, it is determined that an inspection item 1 is “failed”, and in the 35th operation, it is determined that the inspection item 2 is “failed”.

A long-term evaluation point is an index to be used for the long-term quality satisfaction value. The long-term evaluation point is obtained by scoring a failure occurring in each operation. When the long-term evaluation point is calculated, the relationship between the inspection item and the corresponding step is used as illustrated in FIG. 8. In FIG. 8, for example, only the operation in the first assembling step 11 corresponds to the inspection item 1. In the first assembling step 11, the cell A1 handles the product. In the second assembling step 12, the cell B1 handles the product. In the third assembling step 13, the cell C1 handles the product.

When the inspection result information corresponds to an operation performed by one operator (operation performed only in the cell A1), the inspection result information is assigned only to the operation performed by the one operator to calculate the quality-related ability of the one operator who is assigned the inspection result information. Specifically, as illustrated in FIG. 10, the long-term evaluation point is 1 in each of the third and 43rd operations. The long-term evaluation point is 1 for each inspection item.

As illustrated in FIG. 8, the inspection item 2 corresponds to the first assembling step 11, the second assembling step 12, and the third assembling step 13. When the inspection result information corresponds to operations performed by a plurality of operators (operations performed in the cells A1, B1, and C1), the inspection result information is divisibly assigned to all the operations performed by the plurality of operators to calculate the quality-related abilities of the operators who are divisibly assigned the inspection result information. Specifically, as illustrated in FIG. 10, the long-term evaluation point is ⅓ in each of the 35th, 37th, and 39th operations.

The total of the long-term evaluation points during a period from the first operation to the current time point (45th operation) is 7 plus ⅓. A long-term quality satisfaction ratio serves as one index to the long-term quality satisfaction value. The long-term quality satisfaction ratio is calculated based on the total of current long-term evaluation points and the number of target operations. Specifically, the long-term quality satisfaction ratio is calculated based on Expression (1). In this case, the long-term quality satisfaction ratio is 84%.

{1−(7+1/3)/45}×100=84% (1)

Then, the quality-related ability calculation device 27 determines a level of the long-term quality satisfaction value (hereinafter referred to as “long-term quality level”) by using the long-term quality satisfaction ratio. The long-term quality level corresponds to a long-term quality-related ability. The long-term quality level is determined from among a plurality of (for example, five) levels. For example, when the long-term quality satisfaction ratio is high, the operator's long-term quality level is high (for example, level 5). When the long-term quality satisfaction ratio is low, the operator's long-term quality level is low (for example, level 1). Although the long-term quality satisfaction ratio is used as one index to the long-term quality satisfaction value, a different statistic may be used.

A short-term evaluation point is an index to be used for the short-term quality satisfaction value. The short-term evaluation point is basically obtained by scoring a failure occurring in each operation similarly to the long-term evaluation point. The predetermined short term for the short-term evaluation point corresponds to a predetermined number of operations counted from a recent time point when a failure occurs. If the evaluation point of each operation is smaller than 1, the short-term evaluation point is counted when the total of evaluation points reaches 1 over the predetermined short term.

For example, as illustrated in FIG. 10, a failure occurs recently in the 43rd operation. The short-term evaluation point is 1 in the 43rd operation. The predetermined short term corresponds to 10 operations counted from the recent time point when the failure occurs. In this case, the 34th operation to the 43rd operation are targets of the short-term evaluation point. In this period, the long-term evaluation point is ⅓ in each of the 35th, 37th, and 39th operations. The total of the respective long-term evaluation points reaches 1, and therefore the short-term evaluation point is counted as 1 in the 39th operation. That is, the short-term evaluation point is 2 during the period from the 34th operation to the 43rd operation. The total of short-term evaluation points to be counted may be a decimal (or a fraction) similarly to the long-term evaluation point.

A short-term quality satisfaction ratio serves as one index to the short-term quality satisfaction value. The short-term quality satisfaction ratio is calculated based on the total of short-term evaluation points and the number of target operations over the predetermined short term. Specifically, the short-term quality satisfaction ratio is calculated based on Expression (2). In this case, the short-term quality satisfaction ratio is 80%.

{1−2/10}×100=80% (2)

Then, the quality-related ability calculation device 27 determines a level of the short-term quality satisfaction value (hereinafter referred to as “short-term quality level”) by using the short-term quality satisfaction ratio. The short-term quality level corresponds to a short-term quality-related ability. The short-term quality level is determined from among a plurality of (for example, five) levels. For example, when the short-term quality satisfaction ratio is high, the operator's short-term quality level is high (for example, level 5). When the short-term quality satisfaction ratio is low, the operator's short-term quality level is low (for example, level 1). Although the short-term quality satisfaction ratio is used as one index to the short-term quality satisfaction value, a different statistic may be used.

Then, the quality-related ability calculation device 27 determines the quality satisfaction value as illustrated in FIG. 11 by using the long-term quality level (long-term quality satisfaction value) and the short-term quality level (short-term quality satisfaction value). For example, the quality satisfaction value is represented by a plurality of (for example, five) levels. As illustrated in FIG. 11, the level of the quality satisfaction value is determined from among five levels based on a matrix obtained by using five long-term quality levels and five short-term quality levels. Instead of determining the level of the quality satisfaction value based on the matrix, an average of the long-term quality level and the short-term quality level may be used. At this time, weights may be assigned to the long-term quality level and the short-term quality level.

The range fitness value for the high-precision range is derived from the measurement result obtained in the inspection step 14. Specifically, in FIG. 9, the quality-related ability calculation device 27 calculates, as one index to the range fitness value, the ratio of objects included in the high-precision range while objects included in the permissible-quality range are set as a population. The ratio serving as one index to the range fitness value is a numerical value. Then, the quality-related ability calculation device 27 determines a level of the range fitness value (hereinafter referred to as “range fitness value level”) by using the ratio. The range fitness value level is determined from among a plurality of (for example, five) levels. For example, when the ratio serving as the range fitness value is high, the range fitness value level is high (for example, level 5). When the ratio serving as the range fitness value is low, the range fitness value level is low (for example, level 1).

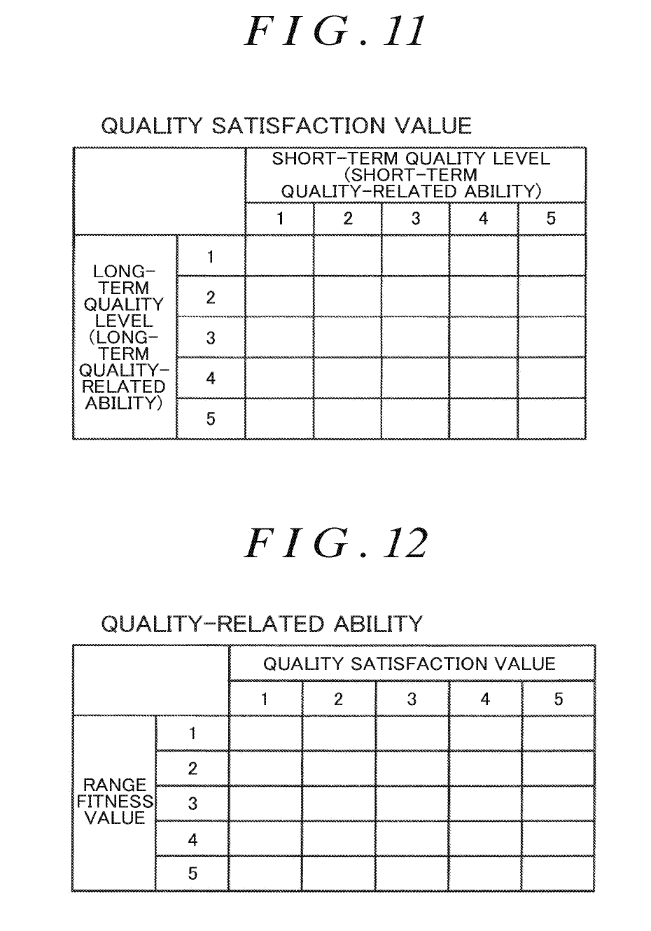

Next, the quality-related ability calculation device 27 determines the quality-related ability as illustrated in FIG. 12 by using the quality satisfaction value and the range fitness value. For example, the quality-related ability is represented by a plurality of (for example, five) levels. As illustrated in FIG. 12, the level of the quality-related ability is determined from among five levels based on a matrix obtained by using five levels of the quality satisfaction value and five range fitness value levels. Instead of determining the level of the quality-related ability based on the matrix, an average of the level of the quality satisfaction value and the range fitness value level may be used. At this time, weights may be assigned to the level of the quality satisfaction value and the range fitness value level.

The general ability calculation device 28 calculates an operator's general ability for each operator based on data on the production-related ability and data on the quality-related ability by causing the computer to execute third arithmetic processing set in advance. The data on the production-related ability is data related to the level of the production-related ability that is calculated by the production-related ability calculation device 23. The data on the quality-related ability is data related to the level of the quality-related ability that is calculated by the quality-related ability calculation device 27.

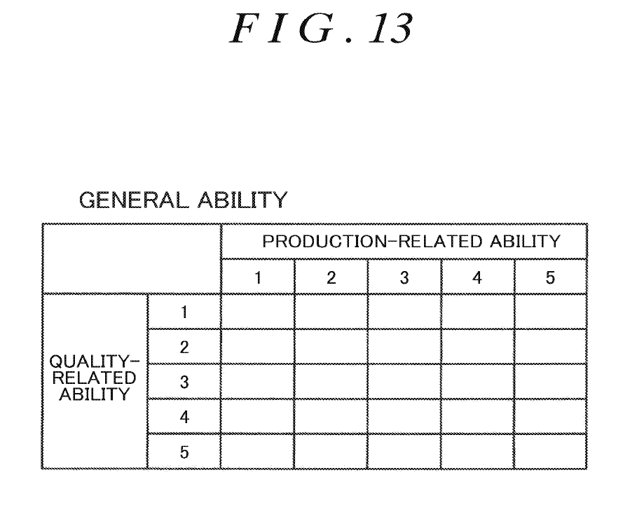

That is, the general ability calculation device 28 determines the general ability as illustrated in FIG. 13 by using the level of the production-related ability and the level of the quality-related ability. For example, the general ability is represented by a plurality of (for example, five) levels. As illustrated in FIG. 13, the level of the general ability is determined from among five levels based on a matrix obtained by using five levels of the production-related ability and five levels of the quality-related ability. Instead of determining the level of the general ability based on the matrix, an average of the level of the production-related ability and the level of the quality-related ability may be used. At this time, weights may be assigned to the level of the production-related ability and the level of the quality-related ability.

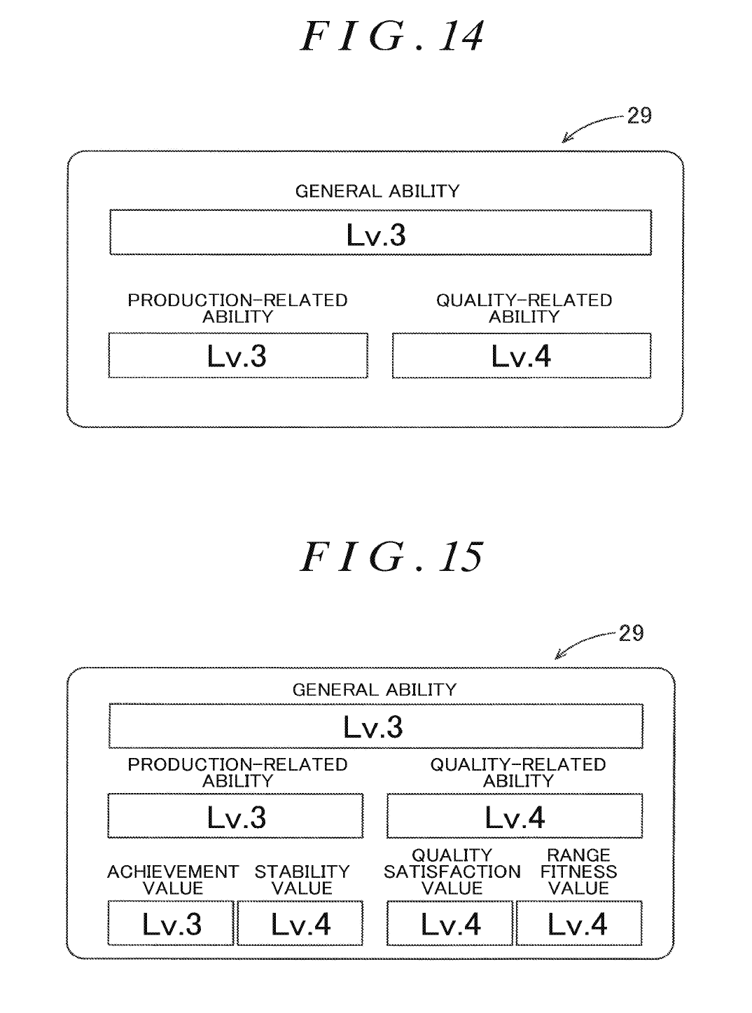

As illustrated in FIG. 14, the presentation device 29 presents the general ability, the production-related ability, and the quality-related ability for each operator. For example, the presentation device 29 may be a stationary terminal or a mobile terminal that can be used by the operator. In this case, an application capable of presenting each ability is installed in the presentation device 29.

In place of the presentation contents illustrated in FIG. 14, the presentation device 29 may present contents illustrated in FIG. 15. As the presentation contents illustrated in FIG. 15, the presentation device 29 presents the achievement value and the stability value that are used for production-related ability calculation and the quality satisfaction value and the range fitness value that are used for quality-related ability calculation in addition to the general ability, the production-related ability, and the quality-related ability.

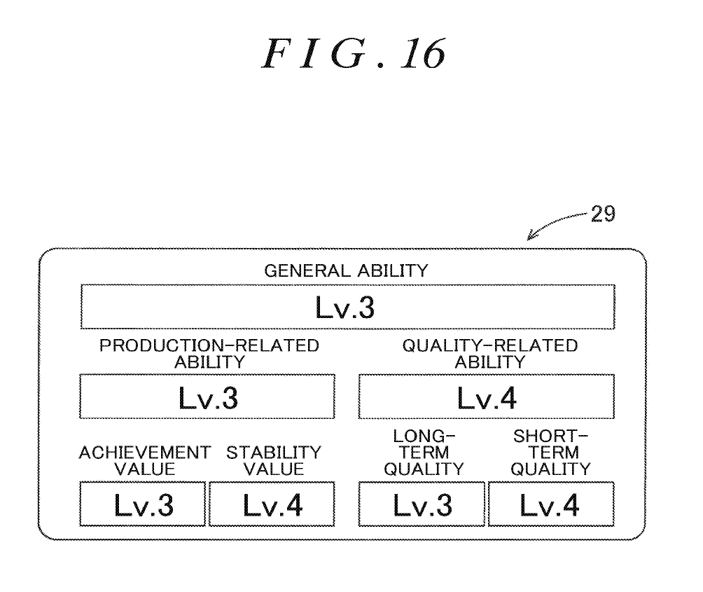

The presentation device 29 may present contents illustrated in FIG. 16. As the presentation contents illustrated in FIG. 16, the presentation device 29 presents the achievement value and the stability value that are used for production-related ability calculation and the long-term quality satisfaction value and the short-term quality satisfaction value that are used for quality-related ability calculation in addition to the general ability, the production-related ability, and the quality-related ability. The presentation device 29 may present the quality satisfaction value and the range fitness value as illustrated in FIG. 15 and the long-term quality satisfaction value and the short-term quality satisfaction value as illustrated in FIG. 16. The presentation device 29 may set the presentation contents as appropriate.

As described above, the operator's general ability is calculated based on the production-related ability and the quality-related ability. The operator's production-related ability is calculated based on the achievement value and the stability value. The achievement value is rated higher as the operation time is shorter. The stability value is rated higher as the variation of operation times of a plurality of operations is smaller. That is, an operator whose operation time constantly achieves the reference time is high in terms of the achievement value and also high in terms of the stability value. Thus, the operator's ability is rated high. For example, in a case of a plurality of operators whose achievement values are approximately equal to each other, the operator who has a significant delay in a case where the operation time does not achieve the reference time is low in terms of the stability value, whereas the operator who has a slight delay in the case where the operation time does not achieve the reference time is high in terms of the stability value. That is, when the achievement values are approximately equal to each other, the operator's ability is rated higher as the stability value is higher. Thus, the operator's ability can be evaluated more appropriately in consideration of the stability value in addition to the achievement value for the reference time.

The operator's quality-related ability is calculated based on the quality satisfaction value and the range fitness value. The quality satisfaction value is calculated based on the inspection result indicating “good” or “failed” in the inspection step 14. The range fitness value is the ratio of higher-precision products to satisfactory products. That is, the range fitness value serves as an index indicating that variation of qualities is smaller. In other words, the operator's quality-related ability is calculated based on an ability to prevent the occurrence of failures and an ability to produce products with higher precision. Thus, the operator's quality-related ability can be evaluated more appropriately.

The quality satisfaction value is calculated based on the long-term quality satisfaction value and the short-term quality satisfaction value. For example, an operator may have an ability to produce products with satisfactory qualities in the long term, but the ability to produce products with satisfactory qualities may decrease in the short term due to a poor physical condition or the like. Alternatively, an operator has not yet had an ability to stably produce products with satisfactory qualities in the long term, but may have an ability to produce products with satisfactory qualities in the short term when the operator exhibits remarkable growth. In those cases, the operator's quality-related ability can be evaluated appropriately.

When operations performed by a plurality of operators are related to the inspection item in the inspection step 14, the result of the inspection item is divisibly assigned to the plurality of operators. If the inspection items can further be categorized, it is possible to grasp that the result of each inspection item corresponds to an operation in one specific step. Even if the inspection items are not categorized completely, the quality-related abilities of the plurality of operators can easily be calculated by divisibly assigning the result of the inspection item to the operators as described above. By causing the presentation device 29 to present the abilities, the operators can easily grasp their abilities.

What is claimed is:

1. An ability evaluation system, comprising:
an operation time acquisition device configured to acquire operation times of operators;
a reference time storage device configured to store reference times of operations; and
a production-related ability calculation device configured to calculate, for each of the operators, a production-related ability of each of the operators based on the acquired operation times and the reference time of a corresponding operation by causing a computer to execute first arithmetic processing set in advance, wherein
the production-related ability calculation device is configured to calculate the production-related ability based on an achievement value that is a ratio at which the acquired operation times of a plurality of operations achieve the reference time, and based on a stability value of the acquired operation times of the plurality of operations.

2. The ability evaluation system according to claim 1, wherein
when the acquired operation times achieve the reference time, the production-related ability calculation device is configured to calculate the achievement value of the operation times of the plurality of operations by substituting the reference time for each of the acquired operation times, and
when the acquired operation times do not achieve the reference time, the production-related ability calculation device is configured to calculate the achievement value of the operation times of the plurality of operations by directly using the acquired operation times.

3. The ability evaluation system according to claim 2, wherein the production-related ability calculation device is configured to calculate the stability value of the operation times of the plurality of operations by directly using the acquired operation times.

4. The ability evaluation system according to claim 1, further comprising:
an inspection result information acquisition device configured to acquire inspection result information obtained in quality inspection conducted as a step subsequent to the operations;
a quality-related ability calculation device configured to calculate, for each of the operators, a quality-related ability for the operations performed by each of the operators based on the inspection result information by causing the computer to execute second arithmetic processing set in advance; and
a general ability calculation device configured to calculate, for each of the operators, a general ability of each of the operators based on data on the production-related ability and data on the quality-related ability by causing the computer to execute third arithmetic processing set in advance.

5. The ability evaluation system according to claim 4, further comprising a corresponding operation storage device configured to store operations corresponding to respective pieces of the inspection result information, wherein
the quality-related ability calculation device is configured to:
assign, when the inspection result information corresponds only to an operation performed by one operator, the inspection result information only to the operation performed by the one operator to calculate a quality-related ability of the one operator who is assigned the inspection result information, and
assign, when the inspection result information corresponds to operations performed by a plurality of operators, the inspection result information to all the operations performed by the plurality of operators to calculate quality-related abilities of the operators who are divisibly assigned the inspection result information.

6. The ability evaluation system according to claim 4, further comprising a quality range storage device configured to store a permissible-quality range and a high-precision range narrower than the permissible-quality range, wherein
the quality-related ability calculation device is configured to calculate, based on the inspection result information, a quality satisfaction value indicating whether a quality falls within the permissible-quality range, and a range fitness value for the high-precision range, and calculate the quality-related ability based on the quality satisfaction value and the range fitness value.

7. The ability evaluation system according to claim 4, wherein the quality-related ability calculation device is configured to calculate the quality-related ability based on a short-term quality satisfaction value obtained as one element of the quality-related ability based on pieces of the inspection result information on the operations performed in a predetermined short term, and based on a long-term quality satisfaction value obtained as another element of the quality-related ability based on pieces of the inspection result information on the operations performed in a predetermined long term.

8. The ability evaluation system according to claim 1, further comprising a presentation device configured to present the production-related ability to each of the operators.

9. An ability evaluation system, comprising:
an inspection result information acquisition device configured to acquire inspection result information obtained in quality inspection conducted as a step subsequent to operations performed by operators; and
a quality-related ability calculation device configured to calculate, for each of the operators, a quality-related ability for the operations performed by each of the operators based on the inspection result information by causing a computer to execute arithmetic processing set in advance, wherein
the quality-related ability calculation device is configured to calculate the quality-related ability based on a short-term quality satisfaction value obtained as one element of the quality-related ability based on pieces of the inspection result information on the operations performed in a predetermined short term, and based on a long-term quality satisfaction value obtained as another element of the quality-related ability based on pieces of the inspection result information on the operations performed in a predetermined long term.
